(19) United States
(12) Patent Application Publication
(10) Pub. No.: US 2006/0271656 A1
(43) Pub. Date: Nov. 30, 2006

(54) System and method for auditing storage systems remotely

(76) Inventor: Yuichi Yagawa, San Jose, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/135,515

(22) Filed: May 24, 2005

(51) Int. Cl. G06F 15/173

(52) U.S. Cl. 709/223

(57) ABSTRACT

A method, apparatus, and system for auditing a storage system remotely that may include one or more host devices, one or more storage systems, and a service center. The host device includes host configuration information and a host probe. The storage system includes an audit agent, at least one resource, storage configuration information, and a storage probe. The service center includes an audit server that may include a global database, a data analyzer, and service information. The audit agent discovers the host devices and other apparatuses connected to the storage system containing the audit agent. The audit agent gathers collected information by collecting the host configuration information, measured data from the host probes, the storage configuration information, measured data from the storage probes, and configuration information and measured data from the connected apparatuses and sends the collected information to a remote audit server securely.

### BACKGROUND

1. Field of the Invention

This invention relates to maintenance service of storage systems, and more specifically to a method, apparatus and system for maintaining or auditing a storage system remotely.

2. Description of the Related Art

Currently, due to the rapid growth of data, it is getting much more difficult for storage system administrators to maintain storage systems and to keep a desired service level from both a capacity and a performance point of view. Specifically, information technology (IT) managers are being asked to keep or even reduce the number of storage system administrators. Further, some customers are interested in outsourcing these administrative tasks.

Moreover, storage system maintenance and management is becoming more complex. Current storage systems have increased functionality. Also, the IT environment where storage systems are being used is getting more complex. Therefore, storage administrators are required to keep more knowledge than ever.

Within a conventional maintenance service, a storage system may contain a service computer. The service computer may collect diagnostic information in the storage system and send it to a service center through a network like a telephone network. One example of this type of conventional service is HiTrack® from Hitachi Data Systems.

Conventional maintenance services have several shortcomings One shortcoming is the ability to diagnose information from the entire storage networking environment as well as from storage systems themselves. Conventional services diagnose information from the storage systems only. Recently, the concept of storage networks and networking has been widely accepted and implemented by some companies and customers. Within a storage networking environment, the storage system may be shared by several hosts and connected to other apparatuses such as switches and directors. Thus, in a storage networking environment, the overall system is complex.

Therefore, it is required for the service to diagnose information from not only storage systems themselves but also other apparatuses connected to the storage systems. Moreover, it is very convenient for users and customers if the service diagnose the storage systems from the hosts' and even the applications' point of view, because one important thing for customers is to keep the application running under a healthy environment.

There are two desires associated with solutions to the above-mentioned shortcomings. Initially, it is desired that there be minimal impact on the storage networking environment. Thus, any impact associated with collecting information from hosts and other apparatuses included in the storage network needs to be eliminated. Further, it is desired that the information be collected and managed in a secure way. The diagnosis information has a lot of confidentiality because it may contain a part of a data center configuration or other sensitive information regarding the storage network system. Service providers must collect and keep all information acquired in a very secure way. Moreover, there should be the ability to provide rich auditing service at a knowledge center. The service provider is expected to be a knowledge center and provide unique services, which conventional services executed on site services is difficult to provide. Currently, there are no solutions for the above-mentioned problems that meet these desires.

Current solutions that do exist, as disclosed in U.S. Patent Application Nos. 22040255004, 20040148379, 20020013908, 20010027470, 20020073356, 20020045976 and U.S. Pat. No. 6,721,685, are related to a remote maintenance system for IT equipment in general, and do not focus on remote maintenance for storage systems. Moreover, none of the current solutions disclose a technology to discover hosts and any other apparatuses that are connected to a storage system. Thus, none of the current solutions provide a remote maintenance service that can diagnose an overall storage networking environment as well as the storage systems.

Therefore, there is a need for a method, apparatus and system for maintaining or auditing a storage system remotely where there is minimal impact on the storage networking environment and the information is collected and managed in a secure way.

### SUMMARY OF THE INVENTION

The present invention is related to a system for auditing a storage system remotely that may include one or more host devices, one or more storage systems, a first network, a second network, a service center, and a third network. The at least one host device includes host configuration information and at least one host probe. The storage system includes an audit agent, at least one resource, storage configuration information, and at least one storage probe. The first network provides an interconnection between the host devices and the storage systems for input/output (I/O) operations. The second network provides an interconnection between the host devices and the storage systems for transferring system management information. The service center includes an audit server that may include a global database, a data analyzer, and service information. The third network provides an interconnection between the service center and the storage systems. The audit agent discovers the host devices and other apparatuses connected to the storage system containing the audit agent. The audit agent gathers collected information by collecting the host configuration information, measured data from the host probes, the storage configuration information, measured data from the storage probes, and configuration information and measured data from the connected apparatuses and sends the collected information to an audit server.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for auditing storage systems remotely according to an example embodiment of the present invention;

FIG. 2 is diagram of a storage system architecture according to an example embodiment of the present invention;

FIG. 3 is a diagram of an interface adapter according to an example embodiment of the present invention;

FIG. 4 is a flowchart of a system discovery process according to an example embodiment of the present invention;

FIG. 5 is a flowchart of a data collector process according to an example embodiment of the present invention;

FIG. 6 is a diagram of a signaling protocol between a data extractor/sender and data receiver/loader according to an example embodiment of the present invention;

FIG. 7 is a diagram of a service information data structure according to an example embodiment of the present invention;

FIG. 8 is a diagram of a global view according to an example embodiment of the present invention;

FIG. 9 is a diagram of a host and storage view according to an example embodiment of the present invention; and

FIG. 10 is a diagram of a site comparison view according to an example embodiment of the present application.

### DETAILED DESCRIPTION

The particulars shown herein are by way of example and for purposes of illustrative discussion of the embodiments of the present invention. The description taken with the drawings makes it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

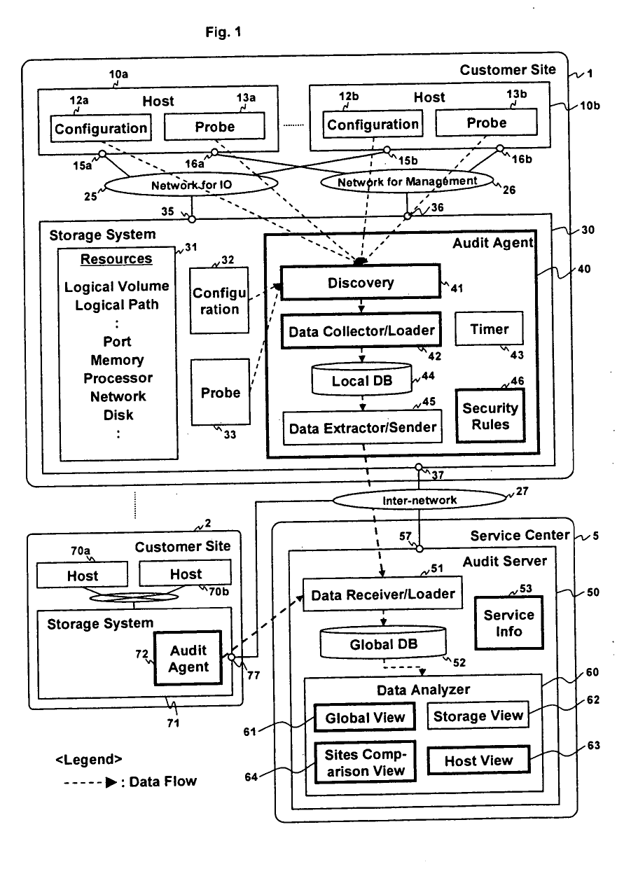

FIG. 1 shows a diagram of a system for auditing storage systems remotely according to an example embodiment of the present invention. According to embodiments of the present invention, an audit agent 40 discovers hosts and any other apparatuses connected to the storage system where the audit agent exists. The audit agent 40 collects configuration information 12 and measured data from those hosts and apparatuses as well as the storage system. The information may be saved in a local database (DB) 44 with timestamps and relationship information regarding relationships between the storage system and the other apparatuses. A part of the configuration information 12 and the measured data may be modified based on security rules, and this modified information sent to an audit server 50. The audit server 50 may save the configuration information and measured data into a global DB 52. An automatic analysis may be performed based on check point rules defined in service information 53, and the result sent to an administrator or auditor immediately.

Further, some views may be provided to support a manual analysis by an administrator or auditor such as, for example, a global view 61 that shows customers' sites on a map, a storage view 62 or host view 63 that shows a topology of entire storage networking environment and performance data on components, and a site comparison view 64 that shows a result of comparison between storage systems at customers' sites, etc. A service provider can diagnose not only the storage systems themselves but also the entire storage networking environment. A sites comparison view can provide a unique analysis due to the global database 52.

The system may include one or more host devices 10a, 10b, and one or more storage systems 30. The one or more host devices 10a, 10b, and one or more storage systems 30 may reside at a customer site 1 and be interconnected via a network for input/output (I/O) 25 and a network for management 26. The system may also include one more other customer sites 2, a service center 5, and a network 27 that interconnects customer sites 1, 2 and the service center 5.

The customer sites contain storage systems 30 that are remotely maintained or audited by the service center 5. The number of customer sites 1, 2 is not limited to two, but there can be several customer sites connected to a service center 5. Moreover, in other embodiments of the present invention several service centers 5 may be included in the overall system. A service center 5 may have its own domain of customer sites 1, 2. Also, a service center may work as a recovery center when another service center is down. In this case, the service centers share data in the global DB by using remote replication and any other methods. The host computers (hosts) 10a, 10b and storage system 30 may be part of a storage networking environment at the customer site 1. There can be several storage systems in the customer site 1. Each storage system that is remotely maintained includes an audit agent 40.

As noted previously, there may be two kinds of networks between the hosts 10a, 10b and the storage system 30, a network for I/O 25 and network for management 26. Through the network for I/O 25, I/O commands and data are communicated between the hosts 10a, 10b and the storage system 30. These networks may be, for example, a Storage Area Network (SAN) or FibreChannel (FC) Network, which is based on a FC and a SCSI protocol, and an Internet Protocol (IP) Network, which may include Network Attached Storage (NAS) as the storage system 30 and may be based on a network file system protocol like NFS and CIFS, or on which iSCSI protocol is used.

Through the network for management 26, management commands and data are communicated between the hosts 10a, 10b and the storage system 30. The network for management 26 may be the same as the network for I/O 25 from a physical point of view, but preferably both are logically independent. A typical network type of the network 26 is IP Network.

The hosts 10a, 10b may include application programs (not shown) and may issue I/O operations through the network for I/O 25 to the storage system 30. Each host may include its own configuration information 12a or 12b that includes relationships between resources on the host. The resources may be, for example, an application, a file system, an operating system, volumes, logical devices, etc. Different technologies of describing a configuration 12a, 12b exist, such as for example, CIM (Common Information Model). CIM is a well known standard provided by DMTF (Distributed Management Task Force), SNIA (Storage Networking Industry Association) and others. According to embodiments of the present invention, the configuration 12a or 12b on each host 10a or 10b may be sent to the storage system 30 or collected by the storage system 30.

Moreover, each host 10a, 10b may include a probe 13a or 13b that may monitor and take measurements on the resources. These measurements may include, for example, measurements of total and used capacities of file systems. One example of current technologies of collecting and describing measurements is CIM. According to embodiments of the present invention, the probe 13a or 13b on each host 10a or 10b may send its measured data to the storage system 30. A protocol between the probe 13a, 13b and the storage system 30 can be a pull or push method based on its implementation. If a pull method is implemented, the measured data may be requested (pulled) from the probe 13a, 13b at the hosts 10a, 10b by the storage system. In contrast, if a push method is implemented, each probe 13a, 13b at the hosts 10a, 10b may send the measured data to the storage system periodically, without being prompted. The probes may be implemented as a software program, for example, a CIMOM (CIM Object Manager), which are detailed in standards provided by DMTF, SNIA and others. The probe may be called as a host agent in general and be shared among system management software. Also, in another embodiment, instead of directly collecting information from the probe or agent, the audit agent collects the same information from the existing management software.

The hosts 10a, 10b may contain interfaces (IFs) 15a-b to the network for I/O 25. An example of the IFs 15a-b is a host bus adapter (HBA) if the network for I/O 25 is FC Network. The hosts 10a-b may also contains IFs 16a-b to the network for management 26. An example of the IFs 16a-b is a network interface card (NIC) if the network for management 26 is an IP network. The storage system 30 may contain an interface 35 to the network for I/O 25 and an interface 36 to the network for management 26. The storage system 30 may also contain an interface 37 to inter-network 27.

The storage system 30 may contain resources 31 such as, for example, one or more logical volumes, one or more logical paths, one or more ports, one or more cache memory, one or more processors, one or more networks, one or more disks, etc. The configuration information 32 may contain information regarding how these resources are configured to fit into the customers' storage networking environment. One example of describing the configuration 32 is SNIA SMI-S (Storage Management Initiative Specification). According to embodiments of the present invention, the configuration information 32 may be sent (pushed) to the audit agent 40 or pulled by the audit agent 40.

A probe 33 at the storage system 30 may measure a performance of each resource. One example of describing the performance information is also SNIA SMI-S. Further, the probe 33 may be implemented as a software program, such as, for example CIMOM. According to embodiments of the present invention, the data measured by the probe 33 may be sent to the audit agent 40 or pulled by the audit agent 40.

According to embodiments of the present invention a storage system may contain an audit agent 40. The audit agent may be implemented as a software program and may include, for example, a discovery process 41, a data collector/loader process 42, a timer 43, a local database (DB) 44, a data extractor 45, and security rules 46. Each process, database and information will be explained in further detail later. According to embodiments of the present invention, the discovery process 41 discovers the configurations 12a-b and the information from the probes 13a-b from the hosts 10a-b that are connected to the storage system 30.

The service center 5 may provide a remote auditing service to each customer site 1, 2. The service center 5 may contain at least one audit server 50. The audit server 50 may be implemented as software program and may contain, for example, a data receiver/loader process 51, a global database 52, service Information 53, and a data analyzer 60. Each process, database and information will be explained in further detail later. The audit server 50 communicates with audit agents 40 at the storage system 30 through an inter-network 27 such as, for example, telephone lines, Internet, etc. The audit server 50 may also include an interface 57 to the inter-network 27.

The data analyzer process 60 may provide maintenance and auditing capability to administrators or auditors within a service provider. The administrators may not need to be in the service center 50 if the data analyzer 60 contains a remote access capability, for example, like web services. The data analyzer 60 may access a global database 52 and provide several analysis views to the administrators. According to embodiments of the present invention, the data analyzer 60 may provide views to an administrator such as, for example, a global view 61, a storage view 62, a host view 63, and a sites comparison view 64. Each view will be explained in more detail later.

As noted previously, there may also be other customer sites 2 that may consist of several hosts 70a-b and at least one storage system 71, in the overall system. An audit agent 72 may communicate with an audit server 50 via an interface 77 and through an inter-Network 27. Configurations of the hosts 70a-b and the storage system 71 are to shown in the figure to eliminate redundant information, since they are similar to the hosts 10a-b and the storage system 30.

In another embodiment, the audit agent includes a data analyzer and provides storage views and host views upon request from a storage administrator. The Local DB contains a good enough history of the collected data to be audited or maintained. The data analyzer provides a remote access capability like HTTP or HTTPS, and the storage administrator audits the storage system remotely.

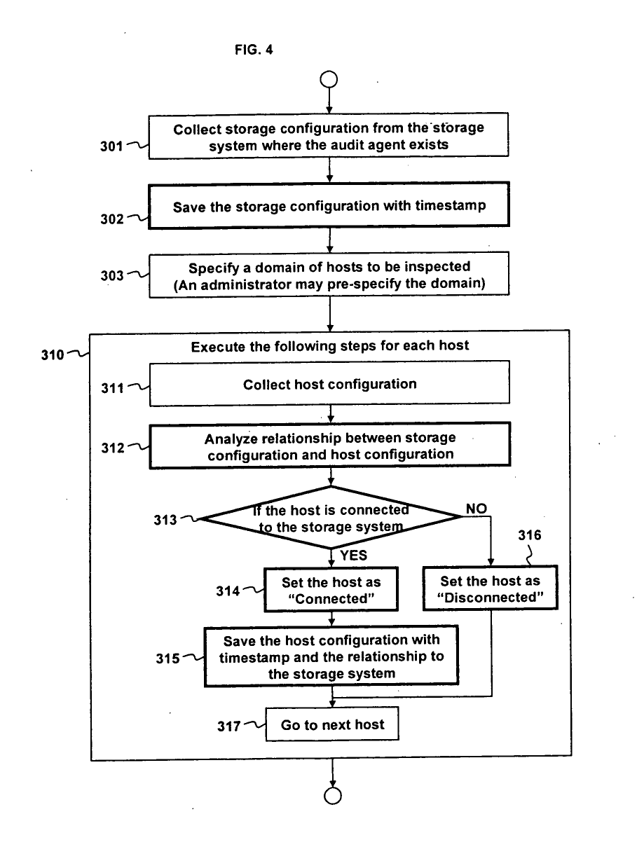

Yet in another embodiment, each host or other apparatus sends its configuration information and measured data with timestamps to the audit server directly. An audit agent on the storage system also sends its configuration and measured data with timestamps to the audit server. The audit server stores the information and analyzes the relationship between the host, the storage and other apparatus using the configuration information. An example way of analysis is the same as described in FIG. 4.

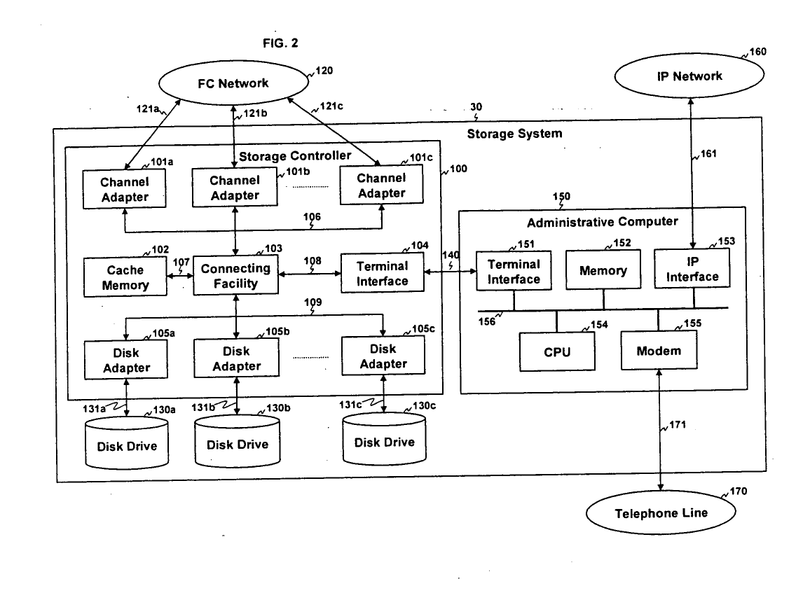

FIG. 2 shows diagram of a storage system architecture according to an example embodiment of the present invention. The storage system 30 may consist of a storage controller 100, multiple disk drives 130a-c, and an administrative computer 150. The storage controller 100 may consist of channel adapters 101a-c, a cache memory 102, a terminal interface 104, one or more disk adapters 105a-c, and a connecting facility 103. Each of these components may be connected to each other through one or more internal networks 106, 107, 108 and 109 and a connecting facility 103. The internal networks 106, 107, 108, 109 may be, for example, FC Network, PCI, Infiniband, etc.

In this example, the network for I/O 25 is FC network 120. The channel adapters 101a-c work as the interface 35 to the FC network 120 via FC cables 121a-c. The disk adapters 105a-c also work as interfaces to the disk drives 130c via a FC cable or SCSI cable 131a-c.

Each channel adapter 101a-c may contain a processor to manage I/O operations from hosts. Also each disk adapter 105a-c may contain a processor to manage data read/write operations to disk drives. The probe 33 may be implemented as a software program on the processors. A terminal interface 104 may provide an interface to an external controller, such as an administrative computer 150. The administrative computer 150 may manage the storage controller 100, and send commands and receive administrative data through the terminal interface 104.

According to embodiments of the present invention, the audit agent 40 may be implemented as software program on an administrative computer 150. The administrative computer 150 may be a typical computer that may include, for example, a CPU 154, memory 152, a terminal interface 151, an IP interface 153, a modem 155, etc. Each of these components may be interconnected through an internal bus network 156, e.g., PCI.

The audit agent 40 may be software executed on the CPU 154. The terminal interface 151 may operate as an interface to the storage controller 100. In this embodiment, the network for management 26 is represented by an IP network 160, such as a LAN (Local Area Network). The IP Interface 153, e.g. a NIC, operates as an interface (e.g., FIG. 1, interface 36) to the IP Network 160. A network connection 161 between the IP interface 153 and the IP network 160 may be, for example, an Ethernet, wireless, or any other IP network path.

A modem 155 may operate as an interface 37 to the inter-network 27, which may be, for example, a telephone line 170. A network connection 171 may be, for example, a modular cable. The modem 155 may initiate connection to the audit server 50 periodically, and as a result the audit agent 40 communicates with the audit server 50. This provides increased security over using a shared communication network such as the Internet. Moreover, other types of secure communications may be used instead of a modem and telephone line. Further, security may also be increased by using encryption, public/private keys, or other methods, alone or in combination with other types of secure communications, which provide some levels of increased security in communications between an audit agent 40 and an audit server 50.

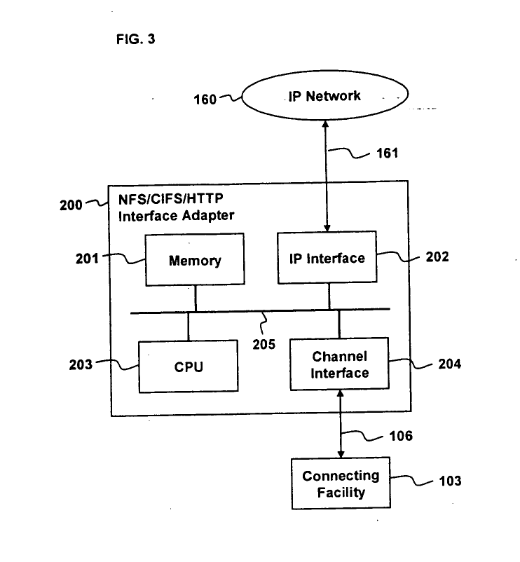

FIG. 3 shows a diagram of an interface adapter according to an example embodiment of the present invention. An audit agent 40 may be implemented as a software program on a channel adapter 200. A storage controller 100 may have more than one specific adapter that has capability to communicate to an IP Network (hereafter IP Interface Adapter). One example of this is NFS/CIFS/HTTP interface adapters, which operate as a NFS/CIFS/HTTP server. The IP interface adapter 200 may include a CPU 203, memory 201, an IP interface 202 and a channel interface 204. Each component may be interconnected through an internal bus network 205, such as, for example, PCI.

An audit agent 40 may be executed on the CPU 203. An IP interface 202 may operate as an interface 36 to the network for management 26, which may be, for example, an IP network 160 or LAN. In this example embodiment, the network for I/O 25 and the network for management 26 are both on the IP network 160. However, the present invention is not limited to this embodiment as different IP addresses may be assigned for I/O and management and still be within the scope of the present invention. Also, the IP interface 202 may also work as the interface 37 to the Inter-Network 27, may be IP Network 160 or wide area network (WAN). Preferably, a secure gateway exists, like a firewall, from the LAN to the WAN. Moreover, the communication between LAN and WAN may be encrypted by using like a VPN (Virtual Private Network).

The communication protocol between an audit agent 40 and an audit server 50 may be, for example, HTTP or HTTPS. The audit agent may be a HTTP client, and the audit server may be a HTTP server. This example embodiment provides more security because it does not require opening new ports in the firewall but uses the ordinary HTTP port number. Also, HTTPS ensures secure end-to-end communication using encryption technologies, such as SSL (Secure Socket Layer). A network connection 161 may be an Ethernet, wireless, or any other IP network connection. The channel interface 204 may communicate with other components on a storage controller through a connecting facility 103.

In another embodiment of the present invention, an interface adapter may include a modem, which may provide an interface 37 to an inter-network 27, i.e. a telephone line 170. The modem may call to an audit server 50 periodically, and as a result the audit agent 40 communicates with the audit server 50.

FIG. 4 shows a flowchart of a system discovery process according to an example embodiment of the present invention. This example discovery process 41 may be performed in an audit agent 40. Storage configurations are collected from the storage system where an audit agent exists, step 301. Each storage configuration collected is saved with a timestamp, step 302. The storage configuration may be saved with a timestamp to allow the audit server to use the timestamp to align configuration information and measured data. A domain of hosts to be inspected may be specified, step 303. An administrator may specify the domain by using administrative software before the discovery process is executed. For each host specified, a host configuration may be collected, step 311. The relationship between the storage configuration and the host configuration may be analyzed, step 312. Then, it may be determined if the host is connected to the storage system, step 313, and if not, a status for the host may be set as “disconnected”. However, if the host is connected to the storage system, step 313, a status for the host may be set as “connected”, and the host configuration with timestamp and the relationship to the storage system may be saved, step 315. Steps 311 through 315 may be repeated for each host, 317.

In general, it may be against a customer's security policy if the audit agent 40 sends to the audit server 50, any information of hosts that are not connected to the storage system 30. Therefore, the activities performed in steps 312-316 may need to distinguish between which hosts are connected to the storage system or not, and therefore, only save configuration information of hosts that are connected to the storage system 30.

One example of a relationship analysis is to use the WWN (World Wide Name) that identifies a unique component like HBA, switch port and storage port in storage networking environment. Storage port WWNs are collected with storage configuration Step 301. A HBA on a host may contain target WWNs within a definition file. The target WWNs in HBA's definition files are also collected with host configuration Step 311. A relationship analysis process may compare the storage port WWNs and those target WWNs in HBA's definition files. Once one of the storage port WWNs is the same as the target WWNs in HBA's definition file, the host that contains the HBA is set as “Connected”. If there is no relationship found, the host is set as “Disconnected”. The relationships may be saved together with the configuration. The relationship may be used when an audit agent 40 collects information from probes 13a, 13b on the hosts. This collected information may be saved with a timestamp just like the collected storage configuration information. The audit agent 40 may also discover any other apparatuses connected to the storage system 30, such as for example, switches or other network devices, by using the same methodology explained above.

Another example of a relationship analysis is to use existing relationship definitions. For example, if zoning or LUN masking is defined in storage network, the definition may include relationship of storage ports and hosts and may be saved in the storage system or the hosts. The information may be collected and used for relationship analysis.

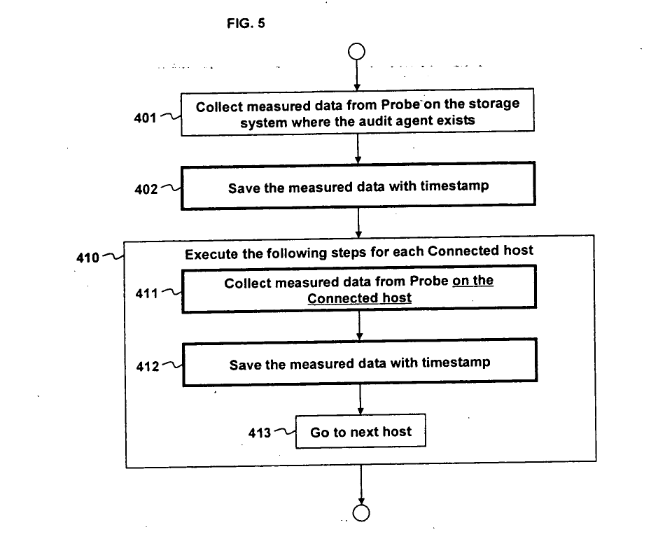

FIG. 5 shows a flowchart of a data collector process according to an example embodiment of the present invention. This process may be performed in a data/collector process 41, and may be executed periodically by using a timer 43. Measured data from a probe on the storage system where the audit agent exists is collected, 401. The measured data may be saved with a time stamp, 402. For each connected host, the measured data from the probe on the connected host is collected, 411. The measured data from the connected host is saved with a timestamp, 412. The steps 411 and 412 are repeated for each connected host, 413. Although not shown, the collection process may continue for other apparatuses connected to the storage system.

Moreover, although in this example embodiment, the process shows the measured data being collected from the storage system and then the measured data being collected from the connected hosts, in other embodiments, the order, i.e., timing, of collecting the measured data from the storage system/hosts may be reversed, performed at the same time, performed at completely different times, etc. Therefore, it is not mandatory to execute the collection of the measured data from the storage system and the hosts (or other apparatuses) during the same timing period.

A local database 44 at an audit agent 40 may save the configuration information and the measured data collected. The local database 44 may be implemented on a DBMS or as ordinary files. As its data structure, ordinary technology found in storage network management software may be adopted, for example, a CIM based. The local database 44 may have a FIFO structure, and data that has been sent to a global database 52 at an audit server 50 may be deleted from the local database 44. In one example embodiment, the local database 44 may also be saved on disk drives 130 at a storage system 30 and be protected by RAID, and not be a part of an internal disk on an administrative computer 150.

The security rules 46 may define the information, in the local database 44 that cannot be sent to the global database 52. The security rules 46 may be defined by customers, and may be stored at an audit agent 40. Security rules 46 may include, for example, “hide any network ID information like WWN or IP address, but keep relationship between components within storage networking environment.” In following this rule, WWN and IP address may be changed into meaningless but identical numbers or characters to keep any relationship between hosts and storage systems while hiding potentially sensitive network ID information like WWN or IP address, e.g., “*****”, “#####”, “55555”, “bbbbb”, etc. An example function that converts the sensitive network ID to the meaningless numbers or characters is One-way Function or Hash Function like SHA-1, MD5 and so on.

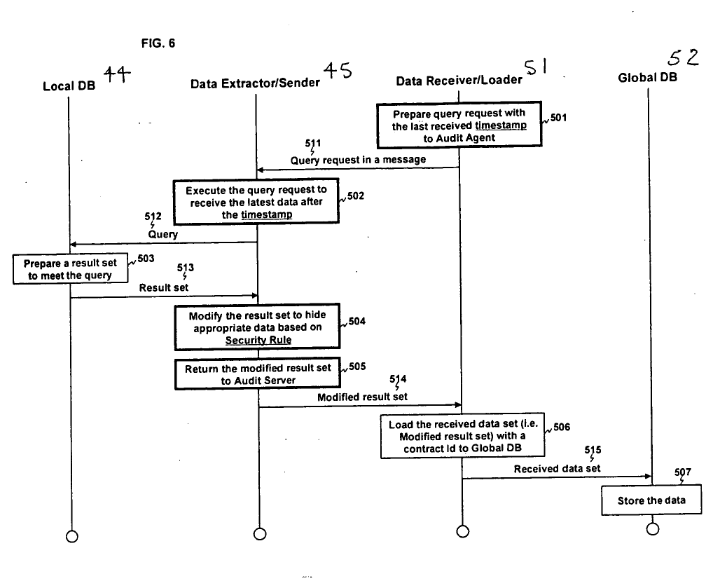

FIG. 6 shows a diagram of a signaling protocol between a data extractor/sender and data receiver/loader according to an example embodiment of the present invention. This protocol may exist between a data extractor/sender 45 and a data receiver/loader 51, and may be executed periodically by using a timer (not shown) in the audit server 50. The process may include a local database (or DB) 44 and a data extractor/sender 45 part of an audit agent 40 in a storage system 30 at a customer site 1, a data receiver/loader 51 and a global database (or DB) 52 that both may reside at an audit server 50 at a service center 5.

The data receiver/loader 51 may prepare a query request with the last received timestamp, 501 and send this query request 511 to the data extractor/sender 45 at an audit agent. The data extractor/sender 45 may execute the query request to receive the latest data after the timestamp, 502, and send a query 512 to the local database 44. The local database 44 may prepare a result set to meet the query, 503 and return the result set 513 to the data extractor/sender. The data extractor/sender 45 may then modify the result set to hide appropriate data based on the security rules 504, and return the modified result set 514 to the data receiver/loader 51 at the audit server, 505. The data receiver/loader 51 may then load the data set (i.e., received modified result set) with a contract ID (explained later) to the global database 506, and send the received data set 515 to the global database. The global database 52 may then store the data 507.

In another example embodiment of the present invention, the data extractor/sender itself may start a trigger. The data extractor/sender 45 may realize the last information that was already sent to the audit server 50, extract the latest information since then from the local DB 44, and send the extracted latest information out to the data receiver/loader 51. This is an example of a push method from the audit agent's point of view.

The global database 52 may keep a set of each of the local databases 44 on the different audit agents 40. Also, the global database 52 may keep a history of each local database 44. Therefore, the global database 52 may contain information of a contract ID, which may be assigned to each audit agent 40 and a service contract with a customer, and information of a timestamp, which distinguishes each history of records. Except those entries, its data structure may adopt a well known technology in the storage networking management software, for example, a CIM based. Also, summary data may be saved in the global database 52 to provide better performance to access for administrators.

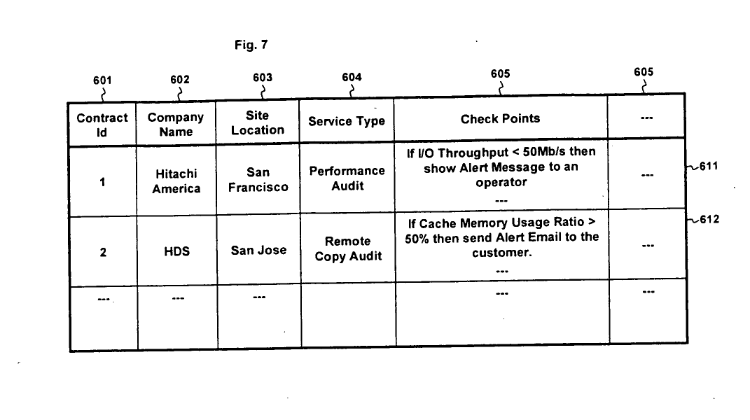

FIG. 7 shows a diagram of a service information data structure according to an example embodiment of the present invention. The service information 53 may contain computer executable service conditions based on service contracts or SOW (Statement of Work). The data structure of service information may include a contract ID 601, a company name 602, a site location of the company 603, a service type 604, check points 605 and others 606. The service type 604 may be a contracted service menu with a customer. For example, a performance audit service type may be to diagnose the storage system 30 from a performance point of view. Further, a remote copy audit service type may be to diagnose the storage systems that are configured for a remote copy operation. Check points 605 define rules, which are used when collected information and data are analyzed. Results of the analysis are reported directly to customers or through administrators at the service center 5 to the customers. Also, the result may be sent immediately to the customers when the rule indicates an immediate feedback to the customer. In general, the check points or rules may vary between customers and may be defined with the customers. This information may also be used within graphical system views, possibly displayed on a graphical user interface (GUI) screen.

According to embodiments of the present invention, in a data analyzer 60, there may be two kinds of analysis, automatic and manual. An automatic analysis may be performed automatically based on the check points 605. A manual analysis may be done by administrators within a service provider. Views may be provided to the administrators to help their manual analysis or auditing. Examples of these will be discussed following.

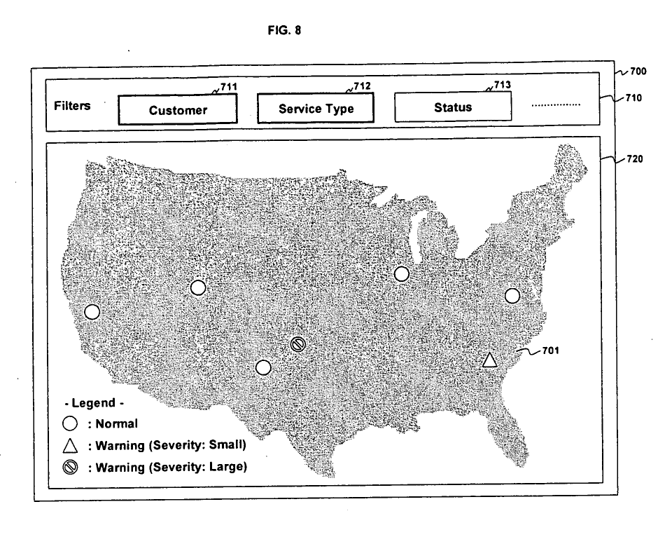

FIG. 8 shows a diagram of a global view according to an example embodiment of the present invention. A global view 700 may include a filter menu bar 710 with filter display options such as customer 711, service type 712, status 713, etc., and a map 720 that displays the selection information. Customer sites can be spread all over the world. Therefore, it may be useful for administrators to see where a particular customer site geographically exists on a map 720. The location information 603 may be used to map the site. The map itself may vary depending on a request from a user by using a menu option (not shown). For example, it the user requests a different region to see, a map of the region will be provided. If the user requests more narrow (or wide) view, the map will be scaled up (or down). Icons on the map may indicate locations of customer sites and latest status of storage systems within the sites. If there is at least one storage system that is not normal in the site, the site may be indicated using warning icons. The status may be automatically analyzed using the check points 605. Filters 710 may be used to show specific sites only. For example, specific customer's sites, which may be spread over the world, can be shown. Also, customers or sites that contract a specific service type can be shown. The administrator selects a site and can make selections to see more detailed information about the site.

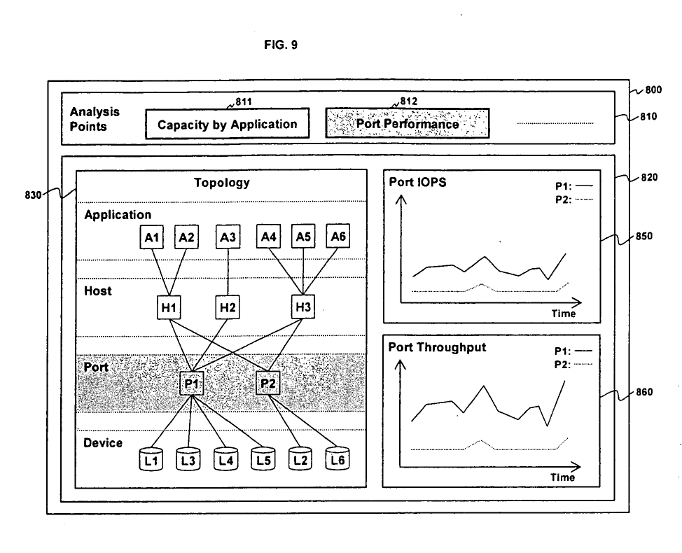

FIG. 9 shows a diagram of a host and storage view according to an example embodiment of the present invention. A host/storage view 800 may include an analysis points menu bar 810 with selection options such as, for example, capacity by application 811, port performance 812, etc. This view may also include a system network topology 830, and performance graphics such as port IOPS 850 and port throughput 860. The topology view 830 may display a storage system and hosts that are connected to the storage system. Therefore, the view includes both a storage view and a host view, in contrast with current remote maintenance systems that only contains a storage view.

In another embodiment of the present invention, the topology view 830 may include switches and any other apparatuses within the storage networking environment connected to the storage system. The topology view 830 may be created using configuration information 12a, 12b, 32 collected from each audit agent 40. The topology view 830 may be created by typical storage networking management software.

When an administrator selects a particular analysis point on the menu 810, the view 800 may show performance data in one or more windows 850 and 860. In this example embodiment, the administrator may realize that the performance workload (IOPS: I/O per second, Throughput) of the port P1 is high, and may also realize that applications A1, A3, A4 and A5, which are using the same port, may have a performance impact because of this. Then the administrator may want to see performance information on those servers to make sure of the effect, or simply report the possible impact on the hosts or the applications to the customer.

In another scenario, the customer may notify that an application A1 slows down from a performance point of view. The customer may then ask for a storage side analysis to the service provider. The service provider realizes the bottleneck may exist on the port P1 that is shared with other applications and may advise the customer to do a load balance on those applications and devices. These analyses can be done because the host view and the storage view are provided together. Further, the view 830 may also show switches and any other apparatuses connected to the storage system 30.

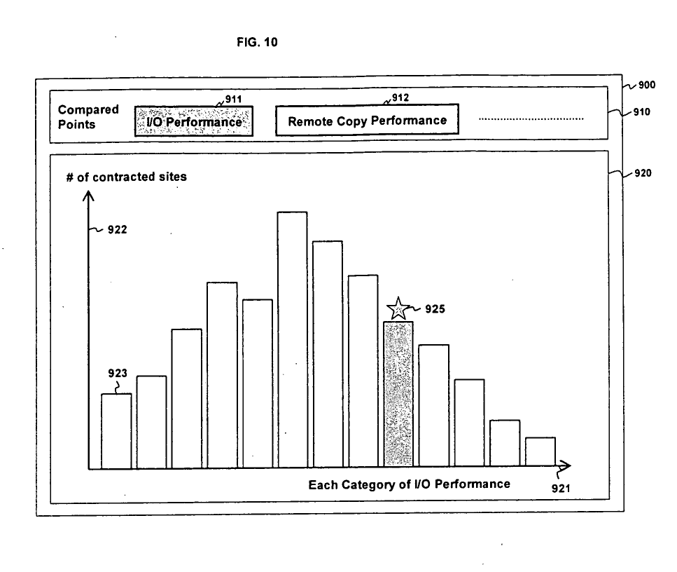

FIG. 10 shows a diagram of a site comparison view according to an example embodiment of the present application. This view 900 may include a compared points menu bar 910 that includes selections such as I/O performance 911, remote copy performance 912, etc, and a site comparison 920. The site comparison 920 may be in the form of a bar chart where each bar represents a number of contracted sites in a category of I/O performance. This type comparison may give a customer an idea of how the performance of the customer's storage system compares with other storage systems, or how different storage systems of the same customer compare. As a knowledge center, an audit server may execute some comparing analysis. The star shows a position of an example customer's storage system. It may be beneficial for customers to understand how well the customer's storage system has been tuned. The customer may realize the storage system can be tuned more. Also, the customer may ask the administrator to recommend some practices that have achieved better performances than the customer's storage system. The comparison view may provide other information like maximum, minimum, mean, and average number of the workload.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A system for auditing a storage system remotely comprising:
at least one host device, the at least one host device including host configuration information and at least one host probe;
at least one storage system, the storage system including an audit agent, storage configuration information, and at least one storage probe;
a first network, the first network providing interconnection between the at least one host device and the at least one storage system for input/output (I/O) operations;
a second network, the second network providing interconnection between the at least one host device and the at least one storage system for transferring system management information;
a service center, the service center including an audit server that includes a global database, a data analyzer, and service information; and
a third network, the third network providing interconnection between the service center and the at least one storage system,
wherein the audit agent discovers the host devices and other apparatuses connected to the storage system containing the audit agent, the audit agent collecting information from the host devices connected to the storage system, the storage system, and the apparatuses connected to the storage system and transferring the collected information to the audit server.

2. The system according to claim 1, the collected information comprising at least one of the host configuration information, measured data from the host probes, the storage configuration information, measured data from the storage probes, and configuration information and measured data from the connected apparatuses.

3. The system according to claim 1, the data extractor/sender module receiving the request and modifying the result set associated with the request based on security rules and sending the modified result set to the audit server.

4. The system according to claim 1, wherein an automatic analysis of the collected information is performed by the data analyzer at the audit server based on check point rules defined in the service information.

5. The system according to claim 1, further comprising at least one resource, the at least one resource comprising at least one of a logical volume, a logical path, a port, a cache memory, a processor, a network, and a disk.

6. The system according to claim 1, wherein the measured data from the storage probe comprises performance information regarding the at least one resource.

7. The system according to claim 1, wherein the storage configuration information comprises information regarding how the at least one resource are configured.

8. The system according to claim 1, where the first network comprises a Fibre Channel network and the second network comprises an Internet Protocol network.

9. The system according to claim 1, wherein the host configuration information includes relationships between resources on the host, the resources on the host comprising at least one of an application, a file system, an operating system, at least one volume, a network interface, and at least one logical device.

10. An audit agent, the audit agent residing at a storage system and comprising:
a discovery module, the discovery module performing operations to discover host devices and other apparatuses connected to the storage system;
a data collector/loader module, the data collector/loader module performing operations to gather collected information from the host devices, the storage system, and the other apparatus;
a local database, the local database receiving and storing the collected information with timestamps and relationship information regarding relationships between the storage system and the host devices and the other apparatuses; and
a data extractor/sender module, the data extractor/sender module receiving a request for at least a portion of the stored collected information.

11. The audit agent according to claim 10, further including security rules, the security rules defining the collected information in the local database that should not be transferred to another network device.

12. The audit agent according to claim 11, wherein the audit agent modifies a result set associated with the request based on the security rules, and transfers the modified result set to the requestor.

13. The audit agent according to claim 10, further including a timer, the timer being used to apply the timestamps to the collected information.

14. The audit agent according to claim 10, wherein the collected information including host configuration information, measured data from host probes, storage configuration information, measured data from storage probes, and configuration information and measured data from the connected apparatuses.

15. The audit agent according to claim 10, wherein the local database prepares a result set of collected data requested to be sent to an audit server.

16. The audit agent according to claim 10, wherein the security rules define the collected information in the local database that should not be sent to an audit server.

17. The audit agent according to claim 10, wherein the data extractor/sender module sends the modified result set to an audit server.

18. An audit server comprising:
a data receiver/loader, the data receiver/loader receiving collected information from at least one audit agent at a storage system;
a global database, the global database storing the collected information;
a memory, the memory containing service information; and
a data analyzer, the data analyzer providing an analysis of the collected information.

19. The audit server according to claim 18, the data analyzer providing an automatic analysis of the collected information based on check point rules defined the service information.

20. The audit server according to claim 18, the global database storing the collected information with a contract identification.

21. The audit server according to claim 18, the collected information including at least one of host configuration information, measured data from host probes, storage configuration information, measured data from storage probes, and configuration information and measured data from the apparatuses connected to the storage system.

22. The audit server according to claim 18, the data analyzer providing at least one view on a graphical user interface (GUI) to an administrator, the administrator using the at least one view to perform manual analysis or auditing, the view including at least one of a global view, a host/storage view, and a sites comparison view.

23. A method for auditing a storage system remotely comprising,
at the storage system:
discovering host devices and other apparatuses connected to the storage system;
collecting system configuration information and measured data from the host devices and the apparatus connected to the storage system; and
storing the collected information and data.

24. The method according to claim 23, further comprising:
storing the collected information and data with a timestamp and relationship information regarding relationships between the storage system, the host devices and the other apparatuses;
preparing a result set of collected data to be sent to an audit server requesting a query; and
sending the result set to the audit server.

25. The method according to claim 23, further comprising:
determining security rules defining the stored collected information that cannot be sent to an audit server;
modifying the result set based on the security rules; and
sending the modified result set to the audit server.

26. The method according to claim 23, the system configuration information including a storage configuration collected from the storage system, a host configuration collected from at least one host connected to the storage system, and an apparatus configuration collected from at least one apparatus connected to the storage system.

27. The method according to claim 23, the collected information including at least one of measured data from host probes, measured data from storage probes, and measured data from the apparatuses connected to the storage system.

28. A storage system comprising:
a storage controller;
at least one disk drive operatively connected to the storage controller; and
an administrative computer operatively connected to the storage controller, the administrative computer including a CPU and a memory,
wherein the CPU executes audit agent software resident at the administrative computer, the audit agent software when executed discovering host devices and other apparatuses connected to the storage system, collecting information from the host devices connected to the storage system, the storage system, and the apparatuses connected to the storage system, and transferring the collected information to an audit server.

29. The storage system according to claim 28, the storage controller further comprising:
at least one channel adapter, the channel adapter proving an interface to the host devices and managing I/O operations from the host devices, the channel adapter further including at least one probe for collecting the storage system information;
a cache memory;
a terminal interface, the terminal interface providing an interface to the administrative computer;
at least one disk adapter, the disk adapter managing read/write operations to the at least one disk drive; and
a connecting facility, the connecting facility interconnecting the at least one channel adapter, the cache memory, the terminal interface, and the at least one disk adapter.

30. The storage system according to claim 28, the administrative computer further including a first network interface for interfacing with the host devices and a second network interface for interfacing with the audit server.

31. The storage system according to claim 28, wherein the first network interface interfaces to one of an IP network, an Ethernet, and a Fibre Channel network.

32. The storage system according to claim 28, wherein the second network interface comprises a modem connected to a telephone line.

33. The storage system according to claim 28, wherein the channel adapter provides an interface to a Fibre Channel network.

34. A system comprising:
at least one host device, the at least one host device including host configuration information and at least one host probe; and
at least one storage system, the storage system including an audit agent, at least one resource, storage configuration information, and at least one storage probe,
wherein the audit agent discovers the host devices and other apparatuses connected to the storage system containing the audit agent, the audit agent collecting information from each said host device connected to the storage system, the storage probes, and each said other apparatuses connected to the storage system, and storing the information in the storage system.

35. The system according to claim 34, the collected information comprising at least one of the host configuration information, measured data from the host probes, the storage configuration information, measured data from the storage probes, and configuration information and measured data from the connected other apparatuses.
